(19) United States
(12) Patent Application Publication
(10) Pub. No.: US 2023/0231190 A1
(43) Pub. Date: Jul. 20, 2023

(54) METHOD OF MAKING ALL SOLID STATE LITHIUM ION BATTERIES

(71) Applicant: HYZON MOTORS INC., Honeoye Falls, NY (US)

(72) Inventors: Zhijun Gu, Naperville, IL (US); Rajesh Bashyam, Delta (CA); Sai Nitin Yellamilli, Naperville, IL (US)

(21) Appl. No.: 18/088,106

(22) Filed: Dec. 23, 2022

Related U.S. Application Data
(60) Provisional application No. 63/294,927, filed on Dec. 30, 2021.
(60) Provisional application No. 63/294,932, filed on Dec. 30, 2021.

(51) Int. Cl. H01M 10/0565; H01M 10/0525; H01M 4/134

(52) U.S. Cl. CPC H01M 10/0565; H01M 4/134; H01M 10/0525; H01M 2300/0094

(57) ABSTRACT

A solid-state lithium-ion battery may include a metal layer. A solid-state lithium-ion battery may include a cathode layer disposed in the metal layer. A solid-state lithium-ion battery may include a reinforced lithiated composite electrolyte layer disposed on the cathode layer. A solid-state lithium-ion battery may include a lithiated ionomer coating layer disposed on the reinforced lithiated composite electrolyte layer. A solid-state lithium-ion battery may include an anode layer disposed on the lithiated ionomer coating layer.

### CROSS-REFERENCE TO RELATED APPLICATIONS

This application claims the benefit of U.S. Provisional Pat. Application Serial No. 63/294,927, filed on Dec. 30, 2021, and U.S. Provisional Pat. Application Serial No. 63/294,932, filed on Dec. 30, 2021. The entire disclosures of the above applications are hereby incorporated herein by reference.

### FIELD

The present technology includes processes and articles of manufacture that relate to solid-state lithium-ion batteries, including all solid-state lithium-ion batteries having reinforced electrolyte.

### INTRODUCTION

This section provides background information related to the present disclosure which is not necessarily prior art.

Rechargeable lithium-ion batteries provide certain advantages, as lithium is the lightest and most electropositive element, which are properties that are important for high energy density. Advantages of lithium-ion batteries include a long shelf life, long cycle life, and the ability to store more energy than lead-acid, nickel-cadmium, and nickel metal hydride batteries. Because of these properties, there is a significant interest centered on optimizing use of lithium-ion batteries in certain applications, including hybrid, plug-in hybrid, and all-electric vehicle applications. Lithium-ion batteries are also used in other applications, such as various portable electronic devices (e.g., cell phones).

All solid-state batteries are gaining significant attention in lithium-ion battery development due to several advantages, including consistent operation, high energy density, and faster charging properties. However, certain challenges remain to be overcome, especially with respect to solid-state electrolytes, in order to improve conductivity and suppress formation of lithium dendrites. Two main approaches are being employed to develop solid electrolytes, the first being the use inorganic ceramic solid electrolytes and the second being use of a solid polymer electrolyte, where both approaches have their own advantages and disadvantages.

Advantages of all solid-state lithium-ion batteries include high energy density and safety. However, while expectations for solid-state batteries are high, there are still issues related to materials, processing, and engineering to overcome. To increase the energy density of solid-state batteries, the cathode electrode loading and thickness needs to be substantially increased, while this can come with a significant trade-off in the utilization of active materials. What is more, optimized particle size distribution of the active materials in the electrode is needed to achieve good performance, good electrolyte utilization, and cycling stability in solid-state based batteries. Currently, in most cases, the cathode active material loading in the electrode is between two and five milligrams per square centimeter to minimize the trade off in utilization efficiency; however, such loading may not provide performance viable for commercial vehicular battery applications.

In all solid-state batteries, certain interfaces between layers can play a significant role in battery performance. These interfaces can be between an electrode and an electrolyte, an electrode and a current controller, and within the electrode itself. Minimizing the electrode and the electrolyte interface can reduce lithium-ion transport resistance. Currently, electrodes can be coated on metal layers, such as aluminum or copper layers, and bonded to an inorganic ceramic solid electrolyte or a polymer electrolyte; e.g., poly(ethylene oxide) based electrolyte.

Accordingly, there is a need to improve the energy density of a solid-state battery, and to reduce a mass of a current collector and electrolyte.

### SUMMARY

In concordance with the instant disclosure, a way to improve the energy density of a solid-state battery by reducing the mass of the current collector and also the electrolyte in a new dual metal design, is surprisingly discovered.

In certain embodiments, the present technology relates to a solid-state lithium-ion battery, including: an metal layer; a cathode layer disposed in the metal layer; a reinforced lithiated composite electrolyte layer disposed on the cathode layer; a lithiated ionomer coating layer disposed on the reinforced lithiated composite electrolyte layer; and an anode layer disposed on the lithiated ionomer coating layer.

In certain embodiments, the present technology relates to a method of making a solid-state lithium-ion battery, including: forming a polymer solution; forming a cathode layer on a substrate; forming an interlayer composition using the polymer solution and a carbonate; coating the cathode layer with the interlayer composition to form a coated cathode layer; and assembling the coated cathode layer into the solid-state lithium-ion battery.

The present technology includes articles of manufacture, systems, and processes that relate to solid-state lithium-ion batteries having certain electrode interlayer constructs, including reinforced lithium-perfluorosulfonic acid and/or composites thereof. Ways of making such solid-state lithium-ion batteries are provided that afford increased cathode electrode loading and thickness. A polymer solution is formed that includes a perfluorosulfonic acid polymer and/or a perfluorosulfonic acid polymer composite. A cathode layer is formed on a substrate and an interlayer composition is formed using the polymer solution and a carbonate. The cathode layer is coated with the interlayer composition to form a coated cathode layer. The coated cathode layer is assembled into the solid-state lithium-ion battery. In this way, the solid-state lithium-ion battery can have at least one interlayer disposed between two cathode layers. Various solid-state lithium-ion batteries are formed in this manner.

Various solid-state electrode and electrolytes can be made according to the present technology. Such electrode-electrolyte composites can be incorporated into all solid-state lithium-ion batteries. Likewise, various batteries, including multicell batteries, can be manufactured using one or more of the electrode-electrolyte composites. Certain applications include vehicles using a solid-state lithium ion battery that incorporates one or more electrode-electrolyte composites made in accordance with the present technology.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a partial schematic cross-sectional view of a first embodiment of a solid-state lithium-ion battery constructed in accordance with the present technology

FIG. 2 is a partial schematic cross-sectional view of a second embodiment of a solid-state lithium-ion battery constructed in accordance with the present technology

FIG. 3 is a partial schematic cross-sectional view of a third embodiment of a solid-state lithium-ion battery constructed in accordance with the present technology.

FIG. 4 is a partial schematic cross-sectional view of a fourth embodiment of a solid-state lithium-ion battery constructed in accordance with the present technology.

FIG. 5 is a flow chart depicting an embodiment of a method of making a solid-state lithium-ion battery constructed in accordance with the present technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature’s relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to increasing lithium-ion transport and increasing conductivity in an electrode for a solid-state lithium battery and addressing challenges associated with cathode electrode design and processing within a solid-state lithium-ion battery. In particular, the solid-state battery made according to the present methods can provide improved energy density within a solid-state lithium-ion battery. The solid-state battery further provides an increase in lithium-ion transport and conductivity by using a reinforced lithiated perfluorosulfonic acid (Li-PFSA) based electrolyte or Li-PFSA ceramic composite electrolyte. The present technology also increases the energy density of the solid-state battery in addition to reducing the cost of making the solid-state battery. In the solid-state battery, certain interfaces between components can play a significant role. Such interfaces include those located between an electrode and an electrolyte, the electrode and a current collector, or within the electrode itself. Minimizing the electrode and electrolyte interface can reduce lithium-ion transport resistance.

Certain solid-state lithium-ion battery designs have electrodes coated on aluminum or copper and bonded to an inorganic ceramic solid electrolyte or polymer electrolyte, such as a poly(ethylene oxide) (PEO) based electrolyte. The present technology changes the nature of such interfaces by providing an solid-state lithium-ion battery assembled using reinforced lithiated-perfluorosulfonic acid (Li-PFSA) and/or Li-PFSA composites that is/are swelled ionically, along with ionically or electronically conducting interlayers and interlayer composites. Ways of making solid-state lithium-ion batteries and solid-state lithium-ion batteries made thereby are provided herein.

A solid-state lithium battery is provided that includes successive layers of an anode layer, a lithiated ionomer coating layer, a reinforced lithiated composite electrolyte layer, a cathode layer, and an aluminum layer. In certain embodiments, the cathode layer can include an interlayer. The cathode layer can include an electrode composition, where the electrode composition includes a cathode active material, a lithiated ionomer, and an electrically conductive additive.

The cathode active material can include the following aspects. The cathode active material can include a metal oxide and/or a metal phosphate. The metal oxide can include one or more of cobalt oxide, iron oxide, manganese oxide, and nickel oxide. The metal phosphate can include one or more of cobalt phosphate, iron phosphate, manganese phosphate, and nickel phosphate.

The lithiated ionomer can include the following aspects. The lithiated ionomer can include a lithiated compound, where the lithiated compound can include one or more lithiated perfluorosulfonic acids. Examples of lithiated perfluorosulfonic acids include one or more lithiated versions of trifluoromethanesulfonic acid, perfluoroethanesulfonic acid, perfluoropropaneesulfonic acid, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, and perfluorodecanesulfonic acid.

The electrically conductive additive can include the following aspects. Examples of the electrically conductive additive include carbon, carbon microfibers, carbon nanofibers, carbon nanotubes, graphite nanofibers, and graphene. Mixtures of various electrically conductive additives can be used. In certain embodiments, the electrically conductive additive can include Super P™, a structured carbon black powder with a moderate surface area, available from Imerys S.A. (Paris, France).

The electrode composition can include the following aspects. The electrode composition can have a ratio of (the cathode active material):(the lithiated ionomer):(the electrically conductive additive) of (60-85):(10-20):(5-20). Certain embodiments include where the ratio of (the cathode active material):(the lithiated ionomer):(the electrically conductive additive) includes 60:20:20, 70:10:20, 70:20:10, 80:10:10, and 85:10:5. The electrode composition can be processed to form a predetermined particle size prior to forming the electrode layer using the electrode composition. Embodiments include where the predetermined particle size can be from 10 nanometers to less than 1 micrometer. Various processes can be employed to form the predetermined particle size, including use of a high shear rotary mixer, a ball mill, various overhead mixers, high pressure mixers, planetary ball mixers, and the like.

The reinforced lithiated composite electrolyte layer can include a lithiated perfluorosulfonic acid. The lithiated perfluorosulfonic acid can include the following aspects. The lithiated perfluorosulfonic acid can have an equivalent weight (EW) of 300 to 1100. The lithiated perfluorosulfonic acid can include one or more of trifluoromethanesulfonic acid, perfluoroethanesulfonic acid, perfluoropropaneesulfonic acid, perfluorobutanesulfonic acid, perfluoropentanesulfonic acid, perfluorohexanesulfonic acid, perfluoroheptanesulfonic acid, perfluorooctanesulfonic acid, perfluorononanesulfonic acid, and perfluorodecanesulfonic acid.

The reinforced lithiated composite electrolyte layer can include a solvent. The solvent can include the following aspects. The solvent can include one or more various organic solvents, including various alcohols, as well as various aprotic solvents, including various amines and cyclic amines. Particular examples of solvents include methanol, ethanol, n-propanol, isopropanol, N-methyl-2-pyrrolidone (NMP), and/or water.

In certain embodiments, the reinforced lithiated composite electrolyte layer can include a ceramic oxide. The ceramic oxide can include various garnet type oxides. Particular examples of the ceramic oxide include one or more of lithium lanthanum zirconium oxide (LLZO), metal (M) doped lithium lanthanum zirconium oxide (LLZMO), lithium lanthanum titanium oxide (LLTO), metal (M) doped lithium lanthanum titanium oxide (LLTMO), and combinations thereof, where the metal (M) can be one or more of aluminum, niobium, and tantalum. Where the ceramic oxide is present, various processes can be employed to ensure the ceramic oxide, as well as other components, have a predetermined particle size, including use of a high shear rotary mixer, a ball mill, various overhead mixers, high pressure mixers, planetary ball mixers, as described herein.

In certain embodiments, the anode layer can be disposed adjacent to the reinforced lithiated composite electrolyte layer. The anode layer can include a first metal layer. The first metal layer can include lithium. The anode layer can further include a second metal layer. For example, the first metal layer can include lithium and can be disposed adjacent the reinforced lithiated composite electrolyte layer, while the second metal layer can include copper and can be disposed adjacent the first metal layer and opposite the reinforced lithiated composite electrolyte layer. Examples include where the anode layer is lithium coated copper. The first metal layer can be a layer of 10 nm to 1000 nm. In some embodiments, the first metal layer can be a layer between 50 nm and 100 nm. The first metal layer can be vacuum deposited through an atomic layer deposition technique or another suitable vacuum deposition technique. In some embodiments, the lithium acts as a seed layer which aids a charging and/or a discharging cycle.

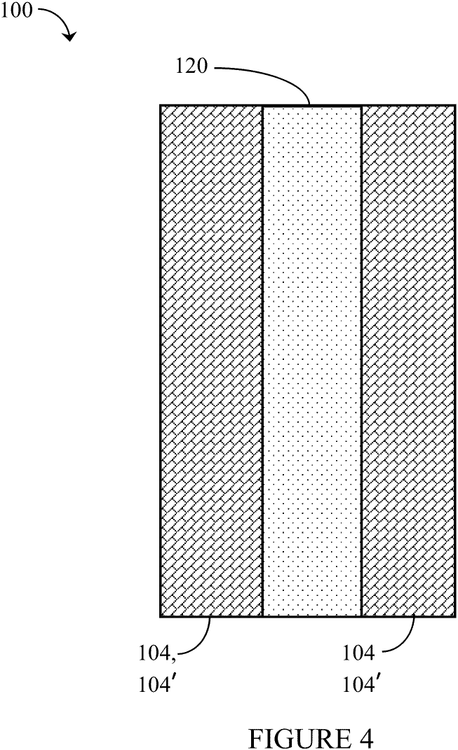

In further embodiments, the cathode layer can include an interlayer, for example, as shown in FIG. 4. Ways of making such solid-state lithium-ion batteries are provided that afford increased cathode electrode loading and thickness. A polymer solution is formed that includes a perfluorosulfonic acid polymer and/or a perfluorosulfonic acid polymer composite. A cathode layer is formed on a substrate and an interlayer composition is formed using the polymer solution and a carbonate. The cathode layer is coated with the interlayer composition to form a coated cathode layer. The coated cathode layer is assembled into the solid-state lithium-ion battery. In this way, the solid-state lithium-ion battery can have at least one interlayer disposed between two cathode layers.

The solid-state battery cell can be insulated by using one or more gaskets between each cell. By replacing a solid ionically conducting electrolyte with a traditional Celgard® separator and filling with a liquid electrolyte after an assembly of a battery, the present technology can be used for liquid state batteries. In some embodiments, the solid catholyte can be replaced by a polyvinylidene fluoride (PVDF) binder with a liquid electrolyte. In some embodiments, to minimize interphase, the electrolyte can be directly coated onto the electrode. In some embodiments, the thickness of the coating layer can have a thickness of 1 micron to 50 micron. Alternatively, in further embodiments, the coating layer comprises between 2 microns and 30 microns. In still further embodiments, the thickness of the coating layer can have a thickness between 2 microns and 10 microns.

Various articles of manufacture can be produced in accordance with the present technology, including various solid-state batteries made according to the present methods. Various solid-state lithium-ion batteries can incorporate the solid-state electrode and electrolyte made according to the present methods. Likewise, various articles and systems employing solid-state lithium-ion batteries can use the present technology. A particular example includes a vehicle that includes a solid-state lithium-ion battery incorporating the solid-state electrode and electrolyte made as described herein.

The present technology can provide certain benefits and advantages in lithium-ion solid-state batteries, including batteries used for various portable and mobility applications such as vehicles. Several issues with respect to lithium-ion batteries are addressed by the present technology, including increasing the lithium-ion transport and conductivity in the electrode and addressing challenges associated with cathode electrode design and processing. In particular, the present technology can increase the lithium-ion transport and conductivity through a novel way of making the reinforced Li-PFSA based electrolyte and a Li-PFSA ceramic composite electrolyte. The electrode-electrolyte composite further optimizes cathode electrode design and processing, increasing durability and stability of the electrode-electrolyte composite, permitting improved handling, and increasing speed and scale of battery manufacture.

### EXAMPLES

Example embodiments of the present technology are provided with reference to the several figures enclosed herewith.

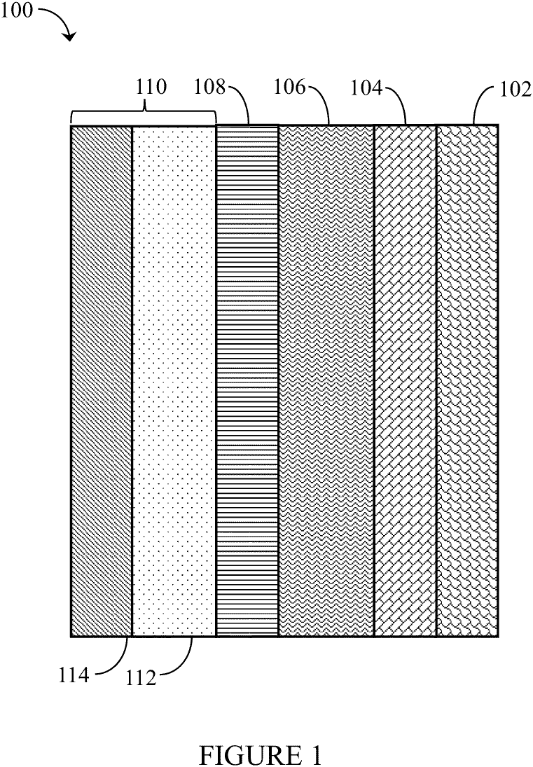

Referring to FIG. 1, a cell design for a lithium-ion battery is shown at 100. A metal layer 102 (e.g., aluminum) can be provided to operate as a current collector. A cathode layer 104 can be disposed on the metal layer 102. A reinforced lithiated composite electrolyte layer 106 including a lithiated ionomer coating layer 108 is disposed on the cathode layer 104. An anode layer 110 having a first metal layer 112, such as lithium, and a second metal layer 114, such as copper, can be disposed on the lithiated ionomer coating layer 108.

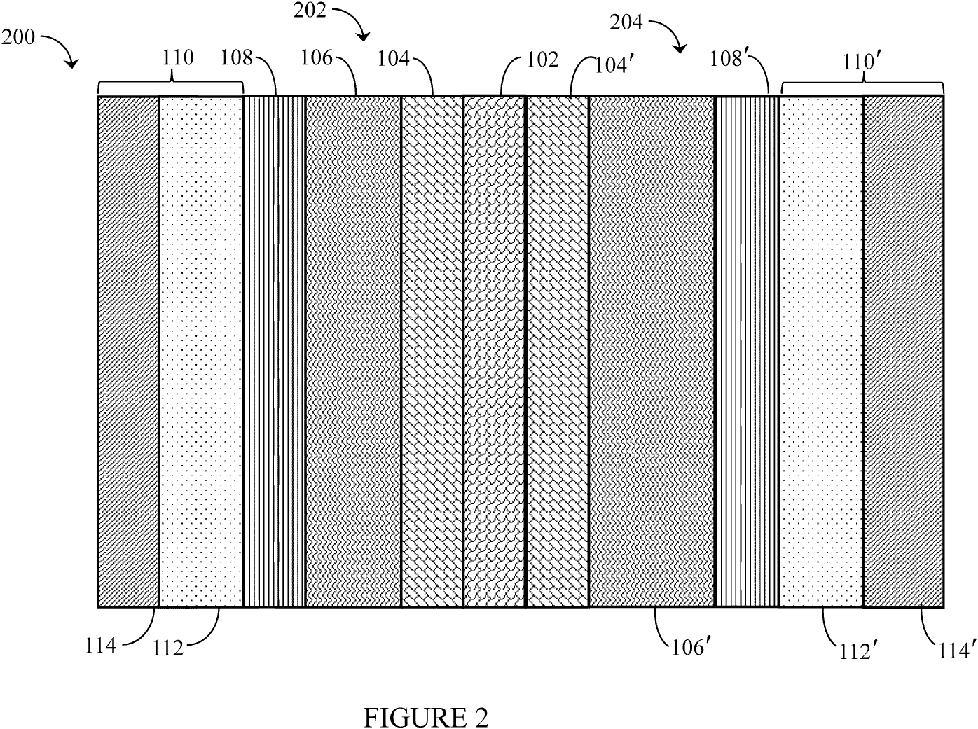

Referring to FIG. 2, a monopolar cell design 200 for a lithium-ion battery is shown. The lithium-ion battery 200 can include a first side 202 and a second side 204. In some embodiments, the second side 204 is a mirror of the first side 202. As shown in FIG. 2, in some embodiments, the first side 202 includes the cell design 100. More specifically, the first side 202 can have an metal layer 102. A cathode layer 104 can be disposed on the metal layer 102. A reinforced lithiated composite electrolyte layer 106 including a lithiated ionomer coating layer 108 is disposed on the cathode layer 104. An anode layer 110 having a first metal layer 112, such as lithium, and a second metal layer 114, such as copper, can be disposed on the lithiated ionomer coating layer 108. Accordingly, the second side 204 of the battery 200 includes a cathode layer 104′ disposed on the metal layer 102. A reinforced lithiated composite electrolyte layer 106′ including a lithiated ionomer coating layer 108′ is disposed on the cathode layer 104′. An anode layer 110′ having a first metal layer 112′, such as lithium, and a second metal layer 114′, such as copper, can be disposed on the lithiated ionomer coating layer 108′.

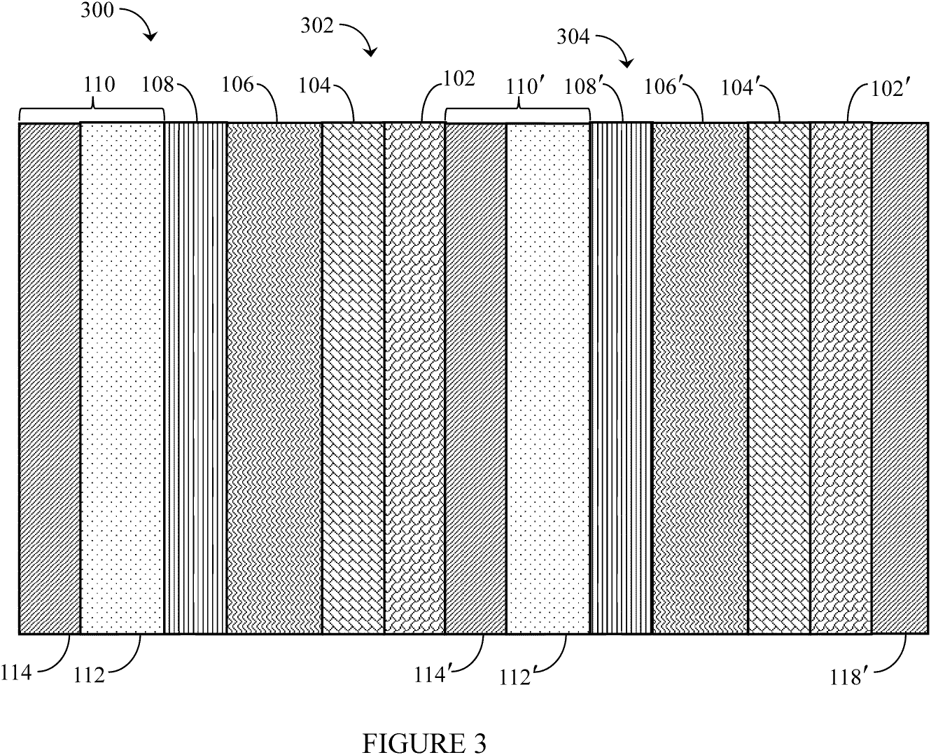

FIG. 3 shows a bipolar design 300 for a lithium-ion battery. As shown within FIG. 3, in some embodiments, the battery 300 includes a stacked cell configuration. The battery 300 can comprise a first side 302 and a second side 304. The first side 302 includes an metal layer 102. A cathode layer 104 can be disposed on the metal layer 102. A reinforced lithiated composite electrolyte layer 106 including a lithiated ionomer coating layer 108 is disposed on the cathode layer 104. An anode layer 110 having a first metal layer 112, such as lithium, and a second metal layer 114, such as copper, can be disposed on the lithiated ionomer coating layer 108. The second side 304 includes another metal layer 102′. A another cathode layer 104′ can be disposed on the another metal layer 102′. Another reinforced lithiated composite electrolyte layer 106′ including another lithiated ionomer coating layer 108′ is disposed on the another cathode layer 104′. Another anode layer 110′ having another first metal layer 112′, such as lithium, and another second metal layer 114′, such as copper, can be disposed on the another lithiated ionomer coating layer 108′. The another second metal layer 114′ is disposed on the another metal layer 102′ of the first side 302. An additional layer of copper 118′ can be disposed on a free side of the another metal layer 102′ of the second side 304.

With reference to FIG. 4, the cathode layer 104, 104′ can include an interlayer 120. A skilled artisan can use any suitable number of interlayers 120, as desired within the cathode layer 104.

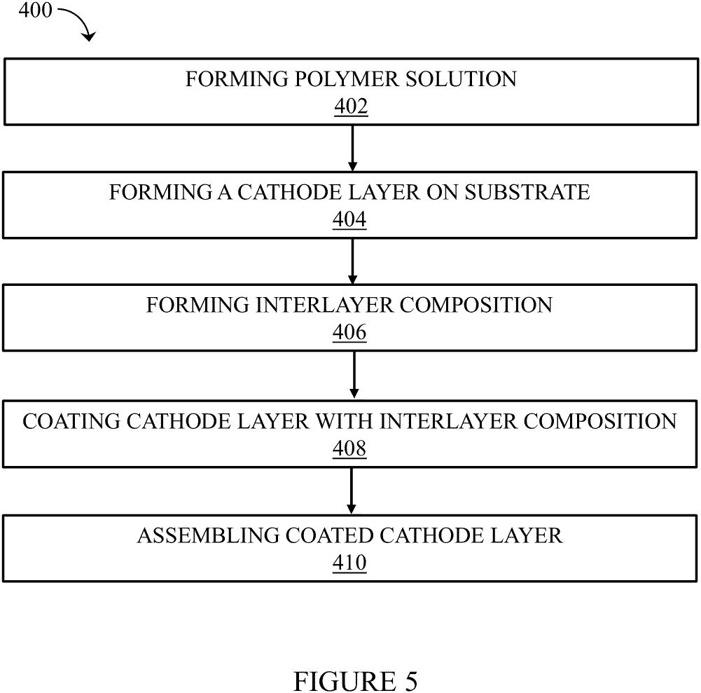

With reference to FIG. 5, a method 400 of making solid-state lithium-ion batteries is shown. The method 400 can include a step 402 of forming a polymer solution that includes a perfluorosulfonic acid polymer and/or a perfluorosulfonic acid polymer composite. A cathode layer is formed on a substrate at 404 and an interlayer composition is formed using the polymer solution and a carbonate at 406. The cathode layer is coated with the interlayer composition to form a coated cathode layer at 408. The coated cathode layer is assembled at 410 into the solid-state lithium-ion battery. In this way, the solid-state lithium-ion battery can have at least one interlayer disposed between two cathode layers.

Embodiments of methods of making solid-state lithium-ion batteries according to the present technology can include the following aspects.

### Step 1: Method of Making Polymer and Polymer-Composite Solutions

Lithiated perfluoro sulphonic acid (EW 300 to 1100) either short chain and its combinations, medium chain and its combinations, and long chain and its combinations, or mixture of short and long chain, mixture of short and medium chains, or mixture medium and long chain or both or combinations thereof, mixed with solvents such as methanol, n-propyl alcohol, isopropyl alcohol, and/or 1-methyl-2-pyrrolidone (NMP). In certain cases, the solvents can also be mixture of alcohols and water or mixture of NMP/alcohol or mixture of NMP/alcohol/water.

Alternatively, the polymer solutions can also be mixed with nano particles of ceramic oxides such as different garnet type oxides such as lithium lanthanum zirconium oxide (LLZO) or lithium lanthanum titanium oxide (LLTO), or their doped oxides such as LLZAO with aluminum doped.

The polymer solutions are mixed under different shear mixtures, such as overhead mixture, high shear rotary mixture, high pressure mixtures. In certain cases, the mixing can also be done under planetary ball milling. The overall particle size after these mixings can be between sub 100 nm to sub-micron.

### Step 2: Cathode Electrode

The cathode electrode with active materials such as lithium nickel manganese cobalt oxide (LiNiₓMn_{y}Co_{1-x-y}O2, herein referred to as NMC) with different nickel concentrations or lithium iron phosphate mixed with Li-PFSA catholyte/binder and conductive carbon such as super P mixed with NMP as solvent or NMP/alcohol as solvent. In certain embodiments, the Li-PFSA composite solution can also be added to the active materials.

The cathode electrode was also coated on membrane to increase the active material loading. In one embodiment, 3 to 5 mg/cm² active materials was coated on aluminum and another 3 to 5 mg/cm² of active material was coated on the reinforced solid electrolyute.

### Step 3: Interlayer Compositions

The interlayer is made of Li-PFSA in alcohol/water mixed with propylene carbonate or mixture propylene carbonate and ethylene carbonate. In another embodiment, the interlayer solutions comprise garnet type oxides such as lithium lanthanum zirconium oxide or LLZO doped with aluminum, niobium, tantalum, tungsten, or other lithiophilic oxides such as TiO2 or aluminium oxides.

In another embodiment, the solutions can also contain electrical additives such as carbon, graphene, and/or carbon nanotubes (CNT).

These solutions are mixed using medium to high shear mixtures.

### Step 4: Coating of Interlayer

The above interlayer solutions are coated or sprayed over cathode electrode coated on aluminum or on the reinforced Li-PFSA or reinforced Li-PFSA garnet or other oxide composite electrolyte or on both. Suitable methods of making reinforced Li-PFSA or Li-PFSA composites are described in Applicant’s co-pending U.S. Appl. Ser. No. 17,706,754, filed on Mar. 29, 2022, published as U.S. Pub. No. 2022/0311044 to Bashyam et al., on Sep. 29, 2022, the entire disclosures of which are incorporated herein by reference.

### Step 5: Bonding Electrode and Electrolyte

Commercial Li coated copper was used as an anode and bonded to the electrolyte side of the cathode and a coin cell was assembled inside the glove.

The present technology can provide certain benefits and advantages in all solid-state batteries, including batteries used for various portable and mobility applications such as vehicles. Several issues with respect to solid-state batteries are addressed by the present technology, including the lithium-ion transport and conductivity within a solid state battery while minimizing a trade off in performance. In particular, a dual metal design can improve the energy density of a solid-state battery by reducing the mass of a current collector and also an electrolyte.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A solid-state lithium-ion battery, comprising:
a metal layer;
a cathode layer disposed on the metal layer;
a reinforced lithiated composite electrolyte layer disposed on the cathode layer;
a lithiated ionomer coating layer disposed on the reinforced lithiated composite electrolyte layer; and
an anode layer disposed on the lithiated ionomer coating layer.

2. The solid-state lithium-ion battery of claim 1, further comprising an interlayer disposed within the cathode layer.

3. The solid-state lithium-ion battery of claim 1, wherein the anode layer includes a first metal layer and a second metal layer.

4. The solid-state lithium-ion battery of claim 3, wherein the first metal layer includes lithium.

5. The solid-state lithium-ion battery of claim 4, wherein the second metal layer includes copper.

6. The solid-state lithium-ion battery of claim 1, further comprising:
a second cathode layer disposed on the metal layer opposite the first cathode layer;
a second reinforced lithiated composite electrolyte layer disposed on the second cathode layer;
a second lithiated ionomer coating layer disposed on the second reinforced lithiated composite electrolyte layer; and
a second anode layer disposed on the second lithiated ionomer coating layer.

7. The solid-state lithium-ion battery of claim 6, further comprising an interlayer disposed within the cathode layer.

8. The solid-state lithium-ion battery of claim 6, wherein the anode layer includes a first metal layer and a second metal layer.

9. The solid-state lithium-ion battery of claim 8, wherein the first metal layer includes lithium.

10. The solid-state lithium-ion battery of claim 9, wherein the second metal layer includes copper.

11. The solid-state lithium-ion battery of claim 1, further comprising:
a second anode layer disposed on the metal layer opposite the first cathode layer;
a second lithiated ionomer coating layer disposed on the second anode layer;
a second reinforced lithiated composite electrolyte layer disposed on the second lithiated ionomer coating layer; and
a second cathode layer disposed on the reinforced lithiated composite electrolyte layer.

12. The solid-state lithium-ion battery of claim 11, further comprising an interlayer disposed within the first cathode layer.

13. The solid-state lithium-ion battery of claim 11, wherein the anode layer includes a first metal layer and a second metal layer.

14. The solid-state lithium-ion battery of claim 13, wherein the first metal layer includes lithium.

15. The solid-state lithium-ion battery of claim 14, wherein the second metal layer includes copper.

16. The solid-state lithium-ion battery of claim 11, wherein a copper layer is disposed on the second cathode layer opposite the reinforced lithiated composite electrolyte layer.

17. The solid-state lithium-ion battery of claim 11, further comprising an interlayer disposed within the second cathode layer.

18. A method of making a solid-state lithium-ion battery, comprising:
forming a polymer solution;
forming a cathode layer on a substrate;
forming an interlayer composition using the polymer solution and a carbonate;
coating the cathode layer with the interlayer composition to form a coated cathode layer; and
assembling the coated cathode layer into the solid-state lithium-ion battery.

19. The method of claim 18, wherein the polymer solution comprises a member selected from a group consisting of a perfluorosulfonic acid polymer, a perfluorosulfonic acid polymer composite, and combinations thereof.

20. A solid-state lithium-ion battery manufactured according to the method of claim 18,
wherein the battery includes a cathode interlayer.
